(19) United States
(12) Patent Application Publication
(10) Pub. No.: US 2008/0292168 A1
(43) Pub. Date: Nov. 27, 2008

(54) Image data acquisition system of an x-ray, CT or MRI machine with an integrated data compression module for data reduction of acquired image data

(76) Inventor: Helmut Winkelmann, Eggolsheim (DE)

Correspondence Address: HARNESS, DICKEY & PIERCE, P.L.C., P.O.BOX 8910, RESTON, VA, 20195, US

(21) Appl. No.: 12/081,275

(22) Filed: Apr. 14, 2008

(30) Foreign Application Priority Data
Apr. 18, 2007 (DE) 10 2007 018 324.2

(51) Int. Cl. G06K 9/00; G06K 9/36

(52) U.S. Cl. 382/131; 382/238

(57) ABSTRACT

A data acquisition and data reduction system (DERS) are disclosed for acquiring and compressing image data generated and loaded by an image data detection unit (DE) of an imaging system (BGS) in which the data acquisition and data reduction system (DERS) is integrated. The imaging system (BGS) can, for example, in this case be a conventional x-ray, computed tomography or magnetic resonance tomography machine for high resolution radiographic, CT or MRI based display of interesting tissue regions of a patient to be examined. At least one embodiment of the present invention relates chiefly to a data compression module (DKM) integrated in the front end of the data acquisition and data reduction system (DERS), and to an associated method for acquiring comprised image data with the aid of which the data throughput rate of an image processing and image visualization system (BVS, AB) connected to the x-ray, CT or MRI machine can be improved. In order to accomplish the data reduction, in addition to loss free, reversible compression and coding methods that are operated, for example, using the principle of run length coding, Shannon Fano entropy coding, Huffman coding or Lempel Ziv Welch coding, it is also possible in at least one embodiment to use lossy compression and coding methods that are based, for example on the principle of discrete cosine transformation, wavelet transformation or geometric or fractal image compression.

### PRIORITY STATEMENT

The present application hereby claims priority under 35 U.S.C. §119 on German patent application number DE 10 2007 018 324.2 filed Apr. 18, 2007, the entire contents of which is hereby incorporated herein by reference.

### FIELD

Embodiments of the present invention generally relate to a data acquisition and/or data reduction system for acquiring and/or compressing image data that are generated and loaded by an image data detection unit of an imaging system in which the data acquisition and data reduction system is integrated. The imaging system can be, in at least one embodiment for example, in this case a conventional x-ray, computed tomography or magnetic resonance tomography machine for high resolution radiographic, CT or MRI-based display of interesting tissue regions of a patient to be examined. In this context, at least one embodiment of the present invention may relate chiefly to a data compression module integrated in the front end of the data acquisition and/or data reduction system, and/or to an associated data acquisition method with the aid of which the data throughput rate of an image processing and image visualization system connected to the x-ray, CT or MRI machine can be improved.

### BACKGROUND

Digital image data are required nowadays in virtually all technical spheres. In addition to the Internet, in which there are scarcely still websites without digital images, digital photography, in particular, is currently experiencing a lively impetus. In other spheres, as well, such as, for example, in the archiving of image documents or in technical quality control, digital images are making more and more ground. If the same quality requirements are placed on them as on classical photography, very large data volumes in the region of a number of megabytes per image result. It follows that an efficient data compression method is mandatory as an intermediate step before these data are transmitted or archived for applications in which large volumes of digital image data occur such as, for example, for most applications in the sphere of multimedia or in the sphere of medical image data processing. The requirements placed on the visual quality of digital images vary extremely in this case. On the Internet, the foreground is mostly occupied by an efficient transmission of the image data that can be attained solely by a strong, lossy compression, the result of which is that the image quality is typically rather low. By contrast, other fields of use such as, for example, medical image data processing require the images to be compressed with as little loss as possible.

Upon adoption of a quantization of the displayable value range to N different color and/or gray scale values (symbols), it is possible to describe acquired image data by m=┌ log₂ (N)┐ bits per pixel. Thus, for coding with m bits/pixel up to N=2^{m} different symbols can be distinguished. It can be shown with the aid of the Shannon source coding theorem, by means of which the minimum data rate for transmitting N statistically independent symbols can be determined, that a digital image with N different color and/or gray scale values Iⱼ of the probabilities of occurrence pⱼ (j being among the natural numbers) is optimally coded (that is to say compressed at the maximum possible compression rate) precisely when each color and/or gray scale value Iⱼ is assigned a code of length L=−log₂ (pⱼ) (in bits per pixel). A source entropy of

$$H = - {\sum }_{j = 1}^{N} {p}_{j} \cdot {log}_{2} ( {p}_{j} )$$

bits per pixel then results for this coding. Independently of how such a code is to be generated, the entropy specifies the theoretical lower bound with which an image can be coded when each pixel is individually coded. If success is achieved in completely decorrelating the pixel values of the image, something which is possible because the gray scale values of adjacent pixels are generally not statistically independent, the entropy of this image now freed from redundancy describes a possible lower limit that specifies which compression factor can be achieved at most. There are two problems to solve in this case: firstly, attempts must be made to extract any inherent redundancy from the image. This is difficult, as a rule, since the exact nature of the dependence of gray scale values of individual pixels on one another, which can also change locally, is unknown. The second problem consists in subsequently designing a code—in a fashion adapted to the probabilities of occurrence of the remaining symbols—that generates a resulting average bit rate comes as close as possible to the previously determined source entropy.

A typical example of the application of modern image compression algorithms in the field of medical image data processing is provided by image data acquisition, image archiving, and image rendering and image visualization systems with a high number of input channels such as occur, inter alia, in conjunction with modern computed or magnetic resonance tomography machines or in the case of x-ray machines equipped with planar detectors. All the systems must be capable of processing high data rates. To date, the image data acquired with the aid of radiological, CT or MRI based imaging have generally been concentrated to form a tree like structure and then passed on to an image archiving or image rendering and image visualization system with the aid of a few high speed data connections for the purpose of storage, further processing and/or graphic display, without a data reduction having taken place previously at a compression rate sufficient to ensure the required data throughput.

Instead of this, the problem of mastering the high data volumes occurring during a CT or MRI based imaging process when archiving, further processing and graphically visualizing these data, and the problem, to be ascribed thereto, of fully utilizing or overloading the processor capacities of an image data acquisition, image archiving, image rendering and image visualization system used to this end is currently solved by skillfully parallelizing processes or threads that are causally independent and therefore can be executed simultaneously (i.e. are concurrent) (multitasking), or by attaining concurrence within individual ones of these processes or threads (multithreading). Moreover, an attempt is made to attain the data throughput rates required for real time processing of the data volumes occurring by using modern high speed data transmission technology with data transmission rates of a few hundred megabits per second up to a number of gigabits per second.

By way of example, U.S. Pat. No. 6,115,488 A discloses an image sequence storage and transmission system in the case of which before being transmitted and stored the acquired data records can still be compressed on the basis of a so-called “hybrid compression technique” with a compression level (up to 100:1 and more), which can be selected by the user, of cascaded compression methods (for example lossless or lossy compression methods in combination with nonlinear time-delayed compression methods).

### SUMMARY

In at least one embodiment of the present invention, the data throughput rate is raised of an image processing and image visualization system that is connected on the input side to an imaging system via a data transmission line.

At least one embodiment of the present invention provides that after having been digitized, the data of a data generating and data acquisition process are already subjected to data reduction at the location where they arrive. The compression factor of a data compression method carried out there to this end is fixed in this case such that there is either no information loss or no clearly perceptible one, whereas the data throughput rate can be raised to an extent required for real time processing of the data.

In detail, at least one embodiment of the present invention relates in accordance with a first aspect to a data acquisition system for acquiring image data that are generated and loaded by an image data detection unit of an imaging system in which the data acquisition system is integrated. The inventive data acquisition system in this case has a data compression module for data reduction of acquired image data which is integrated in the front end of the data acquisition system. The data compression module in this case achieves the goal of improving the data throughput rate of an image processing and image visualization system connected to the x-ray, CT or MRI machine, doing so by adequate compression of the image data to be relayed to the image processing and image visualization system.

Thus, according to at least one embodiment of the invention it is provided that the functionality of the data compression module is implemented within the context of a circuit, integrated in the front end region of the imaging system, that realizes the functionality of the data acquisition system. As stated, the abovementioned imaging system is a conventional x-ray, CT or MRI machine that can be used for high resolution radiographic, computed and/or magnetic resonance tomography display of interesting tissue regions, internal organs, anatomical objects and/or pathological structures in the interior of the body of a patient to be examined.

According to at least one embodiment of the invention, the data reduction required for processing radiological, computed or magnetic resonance tomography image data already takes place here in the front end of a data acquisition system integrated in the x-ray, CT or MRI machine and not, at the earliest, in an image processing and image visualization system connected to a data output interface of the x-ray, CT or MRI machine via a high speed data transmission line.

The inventive data compression module of at least one embodiment can in this case be programmed either for carrying out a loss free, reversible compression and coding method that is based, for example, on the principle of run length coding, Shannon Fano entropy coding, Huffman coding, arithmetic coding or Lempel Ziv Welch coding, or for carrying out a lossy compression and coding method. Here, the latter can be based, for example, on the principle of discrete cosine transformation, wavelet transformation, geometric or fractile image compression. Alternatively, it can be provided according to the invention that the data compression module is programmed for carrying out a lossy context-based compression algorithm (see later for more on this), in the course of which context-based compression algorithm the correlation of gray scale values of adjacent pixels of continuous areas of the same x-ray, MRI or CT tomogram is utilized, the correlation of gray scale values of the same pixels in temporally consecutive CT or MRI tomograms of one and the same slice is utilized, or correlation of gray scale values of the same pixels in spatially adjacent CT or MRI tomograms is utilized to accomplish a data reduction.

In accordance with a second aspect, at least one embodiment of the present invention relates to an imaging system that is connected to an image processing and image visualization system via a data line and is equipped with such a data acquisition system.

### BRIEF DESCRIPTION OF THE DRAWINGS

Further features of the present invention emerge from the dependent patent claims and from the following description of example embodiments of the invention that are illustrated with the aid of the following drawings:

FIG. 1 shows a block diagram for illustrating the system architecture of the inventive image acquisition, image archiving and image rendering system, and

FIG. 2 shows a flowchart of an embodiment of the inventive method.

### DETAILED DESCRIPTION OF EXAMPLE EMBODIMENTS OF THE INVENTION

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In the following sections, the system components of an embodiment of the inventive data acquisition system, and the steps of an embodiment of the inventive method are described in detail with the aid of the attached drawings.

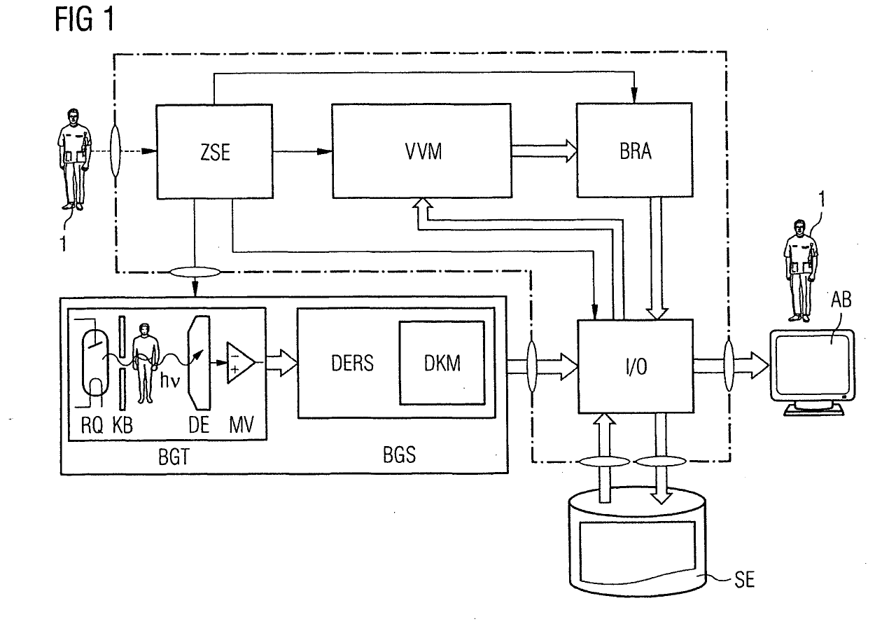

FIG. 1 illustrates a schematic block diagram of an image acquisition, image archiving and image rendering system in accordance with an embodiment of the present invention that renders it possible for image data from the interior of the body of a patient to be examined that are generated by a medical technology imaging system BGS to be acquired, compressed, stored and displayed in graphic form on the display screen AB of a display terminal after the carrying out of an image processing procedure. The imaging part BGT of the abovementioned imaging system BGS can in this case include, an x-ray source RQ and x-ray detector unit DE of a conventional x-ray or computed tomography machine, and/or the exciter and detector coil system of a conventional magnetic resonance tomography machine. However, without limitation of generality, the aim below in the description of this example embodiment is to proceed from the example case of using a CT machine to generate and load the image data, as illustrated in FIG. 1.

Otherwise than for conventional CT systems, in this case the image data loaded by an x-ray detector unit DE via an output-side measuring amplifier MV are compressed by a data compression module DKM in the front end of a data acquisition system (also designated below as data acquisition and data reduction system DERS) integrated in the CT machine using a compression factor that is prescribed or can be prescribed by the user, before they are relayed via a high speed transmission line to an image processing system BVS and read in there via a parallel or serial input/output interface (I/O). In addition to a central control device ZSE that controls the data exchange with the CT machine, and the data exchange between the individual system components of the image processing system BVS, the image processing system BVS can comprise, inter alia, a preprocessing module VVM with a digital filter for noise suppression, contrast improvement and edge detection. Depending on system configuration, upon termination of the preprocessing the image data can be stored, in preparation for a later graphic visualization, either temporarily or persistently in the image data memory of an external storage unit SE, in a fashion linked to the master data of the relevant patient and examination data from earlier examinations of this patient that are held in advance in a patient specific report and/or findings file.

In order for it to be possible to put the filtered image data in two- and/or three-dimensionally rendered form on the display screen AB of a display terminal in graphic form for display upon prompting by the central control device ZSE of the image processing system BVS, they are fed to a 2D-/3D-image rendering application BRA that is integrated in the image processing system BVS and uses the image data, generated by the CT machine and combined to form volume data records, of individual tomograms of interesting tissue regions, internal organs, anatomical objects or pathological structures in the interior of the body of the patient to be examined in order to calculate rendered 2D projections and/or reconstructed 3D views of said areas and image objects that can be displayed from any desired viewing angles. A radiologist examining a patient by computed tomography is able in this case to use an input interface PARAM_IN of the image processing system BVS that is connected to a data input of the central control device ZSE to prescribe and/or modify individual system parameters that are required in the course of the CT scanning operation or in the course of the prepreparation of reconstruction of acquired image data.

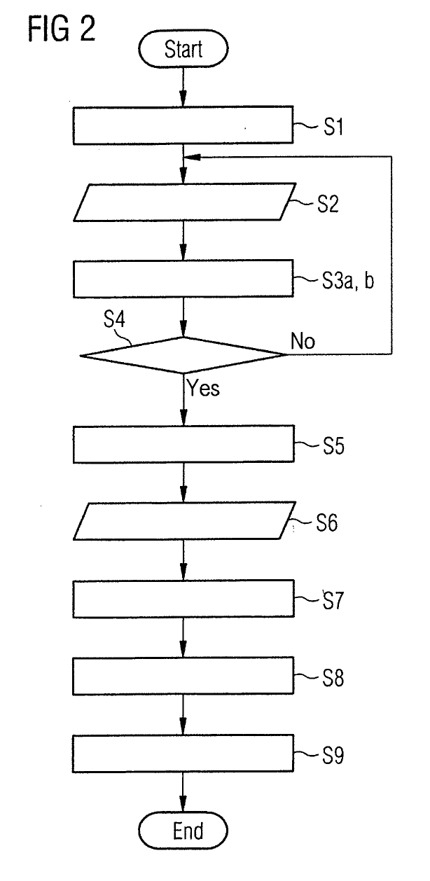

A flowchart that shows the cycle of an embodiment of the inventive method in overall context is illustrated in FIG. 2. The method begins with the execution (S1) of a procedure for generating image data relating to tissue areas, internal organs, anatomical objects and/or pathological structures, which are to be examined, in the interior of the body of a patient to be examined with the aid of a radiological, computed or magnetic resonance tomography imaging system (BGS). Upon acquisition (S2) of the generated image data via a data acquisition and data reduction system DERS integrated in the imaging system, a compression algorithm is executed (S3a) in the way provided by the invention for the data reduction of the acquired image data by a compression factor, that is prescribed or can be prescribed by a radiologist, in the front end of a data acquisition and data reduction system DERS. Subsequently, the compressed image data are buffered (S3b) in a buffer of this data acquisition and data reduction system DERS and output in a stepwise fashion in the form of a serial image data stream composed of individual data blocks, depending on the data transmission capacity of a data transmission line that connects the imaging system BGS to an image processing system BVS used for further processing of the generated image data.

If the imaging process has terminated, something which is determined via interrogation (S4), the compressed image data stream is relayed (S5) to an image processing and image visualization system BVS+AB that is connected via a data input interface RAWDATA_IN to the imaging system and is formed from the image processing and image visualization application running on a display terminal and a display screen AB connected to the display screen terminal. Otherwise, the method is continued again with step S2. Upon receipt of the compressed image data stream, the image data are stored (S6) by the image processing system BVS in the image data memory of an external storage unit SE, in a fashion expediently combined with the master data of the relevant patient and examination data from earlier examinations of this patient that are held in advance in a patient specific report and/or findings file in a memory area of the memory unit SE. After filtering (S7) with the acquired image data in the course of a preprocessing procedure carried out for the purpose of noise suppression, contrast improvement and edge detection, a 2D-/3D-image rendering application BRA is then executed (S8) for graphical visualization of tomograms, reconstructed 2D-projections and/or reconstructed 3D-views of tissue regions, internal organs, anatomical objects or pathological structures (for example tumors, metastases, hematomas abscesses, etc.), that are to be imaged, in the interior of the body of the patient to be examined, whereupon the rendered image data are displayed (S9) in graphic form on the display screen AB of a display terminal.

The compression algorithm used for data reduction in the course of step S3a of the inventive method can in essence be based on four different principles that can be used individually, but also in combination with one another: mention is to be made in this context firstly of code book based algorithms that aim to describe parts of the image data of an image to be transmitted by using identical parts already transmitted. Compression is achieved if this description is more efficient than a direct transmission of the gray scale values for the individual pixels of this image.

A second method resides in making a prediction (forecast) for the pixel value actually to be coded. Only the respective prediction error need be coded for this purpose. If the forecast is good, the entropy of the prediction error turns out to be less than that of the original values. A third method provides for the application of a decorrelating transformation to individual pixel blocks, with the result that the energy of a pixel block is concentrated on a few transformation coefficients and the source entropy is reduced. Again, a fourth method, that resides in using context formation, that is to say a common consideration of pixels of continuous image areas having gray scale values that are the same or similar to a very high degree, to model the conditional probabilities of occurrence of the respective gray scale values of all the pixels in conjunction with assignment to a specific image area, can be used with advantage in the course of step S3a of the inventive method. If success is achieved in combining the individual pixels of an image into as low as possible a number of image areas having gray scale values that are the same or at least similar, the probabilities of occurrence of the gray scale values to be distinguished is increased, the result being to reduce the source entropy and thus to raise the attainable compression factor.

In order to extract the inherent redundancy from the image data of a digital image generated by way of CT or MRI based imaging, for example, it is possible however, for example to perform a prediction of the individual pixel values and/or a transformation of the image data in a first compression step in the course of step S3a of an embodiment of the inventive method. This partial step is typically a linear operation that can be cancelled again by an appropriate inverse operation executed by a decoder of the 2D-/3D-image rendering application BRA on the part of the image processing and image visualization system. It is to be borne in mind here in the case of a lossless image compression that the calculation of the redundancy reduction must be implemented without fail by using integer arithmetic, since the use of floating point arithmetic in the reconstruction of the original image data can produce rounding errors that render lossless reconstruction impossible.

When use is made of a lossy compression method, the next compression step is a requantization of the transformed image data and/or of the prediction error. Here, the image data are specifically quantized with a lower resolution so as to result in a lesser source entropy for the remaining pixel values, and the image data can thereby be further compressed and more easily coded. Because the data are corrupted by the quantization, an error free or lossless reconstruction is no longer possible via the 2D-/3D-image rendering application BRA of the image processing and image visualization system. For this reason, a quantization may not be carried out in the case of a lossless image compression. Entropy coding, however, can be carried out as the last compression step. An attempt is made in this case to determine a code whose average code length as closely as possible approaches the entropy of the data source. A special rise in efficiency can be attained when success is achieved in describing the individual symbols by context as well as possible via their conditioned modeling probabilities of occurrence, that is to say via their probabilities of occurrence in the event of assignment to specific image areas of standard gray scale values.

An example of a further lossy compression and coding method that can be carried out in the course of an embodiment of the inventive method even given low processor power consists in requantizing the displayable gray scale value range of the gray scale values of image points of generated cross sectional pictures from the interior of the body of a patient to be examined that are loaded by the x-ray, CT or MRI machine in the form of a serial image data stream composed of a data sequence of the individual gray scale values. The gray scale values of the individual pixels are stored in this case in a binary coded form of an integer decimal number Z that can be specified in fixed point representation by a real normalized fixed point part m from the range of 1≦m≦2 and an integer exponent e (e being among the natural numbers, including zero) in relation to an integer base b (for example b=10), Z being given by=m·b^{e} in rounded up or down form, that is to say with a reduced decimal position number in the fixed point part m, and said gray scale values are subsequently displayed in graphic form at a low gray scale value resolution, but in return with a larger gray scale value control range, if appropriate.

If each gray scale value (that is to say each symbol) is to be allocated an individual code word, specifically in such a way that the mean code word length is minimized, such a code can be generated, for example, by means of Huffman coding. In this case, however, codes that use less than 1 bit per symbol are impossible. This is critical, in particular, whenever there are symbols with probabilities of greater than 0.5. Remedy is provided here by an arithmetic coding that respectively codes a number of symbols in common and therefore manages to come as close as is desired to the source entropy. The method of arithmetic coding is a compression and coding method that can be carried out without a relatively large outlay on computation and in which symbol sequences generated by a data source (for example an image data stream generated by the x-ray, CT or MRI machine and serialized and consisting of the gray scale values of the individual pixels of cross sectional pictures from the interior of the body of the patient to be examined) are subjected to binary coding without this requiring substantially more bits than prescribed by the ideal entropy of the data source. In contrast with the substantially better known Huffman algorithm, not every symbol is assigned a fixed bit sequence, but there is constructed from the symbol sequence that is to be completely coded a real decimal number (that is to say a floating point number comprising a normalized fixed point part and an exponent specified to the base 10) in the interval [0;1[ that corresponds in binary representation to the compressed data stream—hence the designation “arithmetic” coding. The coding operation runs in the form of an interval nesting, that is to say with each further symbol aᵢ a coding interval in the range [0;1[ is reduced by the factor p(aᵢ), that is to say by the probability of the occurrence of the relevant symbol, the floating point number output as result lying within the respectively reduced interval. The coding operation is directly influenced in this case by a probability distribution, denoted as “model” in arithmetic coding, of the symbols of the symbol alphabet. Consequently, during coding the model can be dynamically adapted to a relatively long symbol sequence without difficulty and without the need, as in the Huffman coding, to firstly reconstruct a code tree.

In detail, the method of arithmetic coding runs as follows: in the course of an initialization phase, the current coding interval I is firstly fixed on the range [0;1[. Thereupon, this interval is decomposed into N subintervals, each symbol aᵢ being assigned exactly one subinterval from a symbol alphabet A={a₁, a₂, . . . , a_{N}}. The length of each subinterval results in this case from the probability of occurrence p(aᵢ) of the relevant symbol aᵢ multiplied by the size of the current coding interval. After the division into subintervals, the current coding interval is replaced by the subinterval corresponding to the respective next symbol aᵢ to be coded. Subsequently, this new interval is subdivided again, and this process is repeated for all the following symbols until no further symbol is to be coded. Thereupon, a search is made for the shortest binary number lying in the interval [0;1[, which lies inside the coding interval. The decimal positions of this binary number are then output as coding result.

An arithmetic coder generally uses two fixed point variables l and h with an accuracy that can be raised at will, which fix the upper and lower limit of the current coding interval. After coding of the respective next symbol aᵢ of a symbol sequence, the coding interval has been reduced to an interval that is bounded by the two interval bounds

$${l}^{′} = l + ( h - l ) \cdot {\sum }_{j = 1}^{i 1} p ( {a}_{j} ) and$$

$${h}^{′} = l + ( h - l ) \cdot {\sum }_{j = 1}^{i} p ( aj ) = l + ( h - l ) \cdot p ( {a}_{i} )$$

The new coding interval is smaller in this case than the previous one by the factor p(aᵢ). After coding of the last symbol, l is rounded up until it still holds that l<h, and the decimal positions of l are then output as coding result.

For the purpose of decoding, an arithmetic decoder firstly reads in a complete decimal floating point number that corresponds to a binary code sequence and includes a fixed point part and an exponent specified in relation to the base 10, and stores said exponent in a fixed point variable x. Subsequently, as in the case of the coding operation the two bounds of the coding interval are fixed at l=0 and h=1 in the course of an initialization phase, whereupon the transition to the respective next smaller coding interval is undertaken exactly as in the case of the coding operation. However, whereas with the coder the known next symbol aᵢ selects the next coding interval from the N subintervals of the decomposition, in the case of the decoding operation it is the number x read in that determines which subinterval is the subsequent coding interval. The selected subinterval determines, furthermore, which decoded symbol is loaded at the output of the decoder. In the case of a current coding interval [l; h[, a search is made in the decoder for that i for which the inequality chain

$$l + ( j - l ) \cdot {\sum }_{j = 1}^{i 1} p ( aj ) \leq x < l + ( j - l ) \cdot {\sum }_{j = 1}^{i} p ( {a}_{j} )$$

is fulfilled. The symbol aᵢ is then output, and the new coding interval is [l′; h′[ as in the coding operation.

As already mentioned, the compression algorithm used in step S3a of an embodiment of the inventive method for the purpose of data reduction can also be a context-based compression algorithm that utilizes statistical dependencies of the gray scale values of adjacent pixels in order to remove or to reduce redundancies contained in the image data generated by the imaging system BGS. This can be done, for example, by utilizing the correlation of gray scale values of adjacent pixels of continuous areas of the same x-ray picture, CT or MRI tomogram, the correlation of gray scale values of the same pixels in temporally consecutive CT or MRI tomograms of one and the same slice, and/or the correlation of gray scale values of the same pixels in spatially consecutive CT or MRI tomograms. The statistical dependencies of the individual pixel gray scale values upon one another are modeled in this case by using context variables. A context denotes a specific constellation of a restricted set of adjacent, already coded pixels. An improvement of the compression can be attained by the context formation wherever the value of the pixel to be coded can be forecast as well as possible, that is to say when the probability of the symbol to be coded is raised. The entropy can be reduced in this case by using suitable contexts K. The aim is to differentiate the probabilities of the pixel values as well as possible for different contexts. Enlarging the context region increases the number of possible contexts, and this enables an improved modeling of the probabilities. However, excessively large context regions are problematic, since they result very quickly in an extremely large number of contexts that can be greater than the number of pixels in the image. When a specific pixel is being coded with the aid of a special context during coding, it can happen that this context has never yet occurred, and it is therefore impossible to estimate any sensible probabilities.

In order to reduce the value range of the pixel values to be coded, a next step can reside in quantizing context variables, that is to say combining specific value ranges for context formation in order thereby to arrive at a number of contexts that can be handled. A very good example of the use of context formation and context quantization is the very powerful image compression by means of CALIC. CALIC stands for “Context-based Adaptive Lossless Image Compression” and was passed in 1995 by ISO as the best method for searching a new standard for lossless image compression. CALIC uses two different context types in this case. After an adaptive prediction, modeling of the prediction error is carried out. To this end, the prediction error energy is estimated from the gradient of the adjacent pixels and the adjacent prediction error. This estimate is quantized in the four ranges. It is also detected whether the surrounding pixels are greater or less than the prediction value. These two items of information together form 576 possible contexts for modeling the prediction errors in the case of different image textures. However, it is not the distribution of the prediction errors that is modeled, but “only” the expectation of the prediction error. This value can be used as further improvement of the prediction, since it is learned to what extent a predictor fails in specific contexts. Eight contexts are used in the subsequent coding of the prediction error. The classification is performed via the prediction error energy to be expected. The JPEG-LS standard, adopted in 1997, for lossless image compression, which is also known as LOCO, emerged essentially from a simplified version of CALIC.

The new JPEG2000 image compression standard also permits a lossless compression of image data that can be used in the course of step S3a of an embodiment of the inventive method. The first step here is to carry out a reversible integer wavelet transformation. The wavelet decomposition is subdivided into blocks that, for their part, are decomposed into their bit planes that are then entropy coded with the aid of an arithmetic coder. The eight surrounding positions are used for forming the context of a bit of a coefficient. Nine contexts are distinguished overall. Owing to the fact that each block is coded independently from the other, a good possibility results for adapting to local fluctuations of the image statistics. Owing to the decomposition into bit planes, JPEG 2000 permits a progressive transmission of the data so that, for example, a preview can be generated from a fraction of a lossless coded JPEG2000 file.

The advantages of the data reduction carried out, in accordance with an embodiment of the invention, in the front end of the data acquisition system consist, in particular in that the image processing system BVS need not be equipped with the most modern technology for ensuring high data processing speeds, the result being that the cost outlay for the entire system can be substantially lowered. In addition, image processing systems with low processor power and thus low processing speed are more easily available than those with a higher data throughput rate. If the inventive imaging system BGS equipped for carrying out efficient data reduction of acquired image data is used in conjunction with a modern high speed image processing system BVS, it is possible to attain processing speeds that are yet higher.

Carrying out one of the abovementioned compression and coding methods in the front end of the data acquisition system DERS has, moreover, the advantage that the processor power loss of the image processing system BVS connected on the output side to the imaging system BGS drops at low clock rates. If customer-specific integrated circuits are used in the front end region of the data acquisition system DERS, something which is frequently the case, the data compression function can already be integrated there and therefore requires no further implementation costs. A further cost saving implementation of this data compression function results in the event of a combination of the compression and coding methods used for data reduction with the first step of the concentration, mentioned at the beginning, of acquired image data to form a tree like data structure.

Further, elements and/or features of different example embodiments may be combined with each other and/or substituted for each other within the scope of this disclosure and appended claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A data acquisition system for acquiring image data generated and loaded by an image data detection unit of an imaging system in which the data acquisition system is integrated, the data acquisition system comprising:
a data compression module, integrated in a front end of the data acquisition system, to carry out a data reduction of acquired image data, and functionality of the data compression module being implemented in a context of a customer-specific integrated circuit in the front end region of the imaging system which realizes the functionality of the data acquisition system.

2. The data acquisition system as claimed in claim 1, wherein the data compression module is programmed for carrying out a loss free, reversible compression and coding method.

3. The data acquisition system as claimed in claim 2, wherein the loss free, reversible compression and coding method is based on a principle of at least one of run length coding, Shannon Fano entropy coding, Huffman coding, arithmetic coding and Lempel Ziv Welch coding.

4. The data acquisition system as claimed in claim 1, wherein the data compression module is programmed for carrying out a lossy compression and coding method.

5. The data acquisition system as claimed in claim 4, wherein the lossy compression and coding method is based on a principle of at least one of discrete cosine transformation, wavelet transformation, geometric and fractal image compression.

6. The data acquisition system as claimed in claim 1, wherein the data compression module is programmed for carrying out a lossy context-based compression algorithm.

7. The data acquisition system as claimed in claim 6, wherein, in the course of the context-based compression algorithm, the correlation of gray scale values of adjacent pixels of continuous areas of the same x-ray, MRI or CT tomogram is utilized to accomplish a data reduction.

8. The data acquisition system as claimed in claim 6, wherein, in the course of the context-based compression algorithm, the correlation of gray scale values of the same pixels in temporarily consecutive CT or MRI tomograms of one and the same slice is utilized to accomplish a data reduction.

9. The data acquisition system as claimed in claim 6, wherein, in the course of the context-based compression algorithm, the correlation of gray scale values of the same pixels in spatially adjacent CT or MRI tomograms is utilized to accomplish a data reduction.

10. An imaging system, connected via a data line to an image processing and image visualization system, wherein the imaging system comprises a data acquisition system as claimed in claim 1.

11. An imaging system, connected via a data line to an image processing and image visualization system, the imaging system comprising:
an image data detection unit to detect image data;
a data acquisition system to acquire image data detected by the image data detection unit, the data acquisition system including,
a data compression module to carry out a data reduction of the acquired image data, functionality of the data compression module being implemented in a context of a customer-specific integrated circuit in a front end region of the imaging system which realizes the functionality of the data acquisition system.

12. The imaging system of claim 11, wherein the data compression module is integrated in the front end of the data acquisition system.

13. The imaging system of claim 11, wherein the imaging system is at an x-ray, CT or MRI machine.

14. The data acquisition system of claim 1, wherein the imaging system is at an x-ray, CT or MRI machine.
